(19) United States
(12) Patent Application Publication
(10) Pub. No.: US 2006/0225402 A1
(43) Pub. Date: Oct. 12, 2006

(54) Mobile power system emissions control

(76) Inventors: George Kierspe, Palm Beach Gardens, FL (US); John Bacile, Wellington, FL (US); Scott W. Smith, Palm Beach Gardens, FL (US); William J. Hartig, Cincinnati, OH (US); Brian D. Hulse, Harrells, NC (US)

Correspondence Address: WINSTON & STRAWN LLP, 1700 K STREET, N.W., WASHINGTON, DC, 20006, US

(21) Appl. No.: 11/075,524

(22) Filed: Mar. 9, 2005

Related U.S. Application Data
(60) Provisional application No. 60/551,019, filed on Mar. 9, 2004.
(60) Provisional application No. 60/551,023, filed on Mar. 9, 2004.
(60) Provisional application No. 60/551,031, filed on Mar. 9, 2004.

(51) Int. Cl. F02C 7/00

(52) U.S. Cl. 60/39.5

(57) ABSTRACT

An emissions control system efficiently reduces combustion waste products emitted from a trailer-mounted mobile electrical power generation system. The invention also reduces noise levels associated with power generation. The invention includes several road-transportable duct modules that can be connected together. One module directs the flow of combustion gases from the exhaust of a combustion engine in a power trailer and also provides noise attenuation. Another module mixes the combustion gases with a urea mixture. A third duct module houses a catalyst for removing combustion waste products.

### CROSS-REFERENCE TO RELATED APPLICATIONS

This application claims the benefit of U.S. Provisional Application Nos. 60/551,019, 60/551,023 and 60/551,031 filed Mar. 9, 2004, which are hereby incorporated by reference in their entirety.

### FIELD OF THE INVENTION

The invention relates to an emissions control system, and more particularly, to an emissions control system for a trailer-mounted mobile electrical power generation system.

### BACKGROUND OF THE INVENTION

Mobile power generation systems capable of delivering several or more megawatts of power have been known to offer certain advantages compared to power delivered from the electrical power or utility distribution grid. The mobile power generation systems can provide power as needed at times of peak demand or of brownout in the distribution grid, or in cases of need because of some emergency or other problem in the distribution grid as a result of a power grid failure or some other type of disaster. The mobile power generation systems also can be located at places distant from the distribution network where there is a need for power. There is then no need for the delay or expense of arranging for or construction of power lines to the distant or remote places. Some years ago, there were attempts made to provide electric power in trailer-mounted generator systems. An example of such a trailer mounted generator system is described in a magazine article entitled “Megawatts on Wheels” written by C. F. Thompson, C. R. Boland and E. Bernstein in the March 1971 issue of Combustion, pages 24-30. For various reasons, these types of generator systems did not, so far as is known, achieve any extended use and were not widely adopted.

As noted above, mobile power generation systems have certain desirable features and advantages. They have again recently become the subject of interest. However, there are a number of factors that give rise to problems with these earlier types of trailer mounted generator systems.

For optimum use, such a system needs to comply with weight and height restrictions from relevant highway regulatory and governmental agencies. Also, there are environmental limitations on the type and acceptable concentration levels of combustion waste products produced by this equipment. In addition, noise from the various components of the generator systems must be kept within presently established regulatory limits.

There were competing considerations regarding mobile power generation systems of this type. On the one hand, limits on weight and size of the systems had to be observed if the systems were to be highway transportable and thus available for widespread use. In conflict with this were the environmental and noise abatement considerations. Further, mobile power generation systems should be self-supporting in that they could bring to the site all equipment necessary to assemble the system in a relatively few days without the need for other equipment such as cranes, hoists and the like. It was felt by at least some that achieving suitable limits on combustion gas product emissions and noise levels could not be achieved while complying with height and weight limits for highway travel.

An example of a system that provides an improved mobile trailer-mounted power generation system is described in U.S. Pat. No. 6,786,051 to Kristich and Hulse, which is hereby incorporated by reference in its entirety. The mobile power system described there includes a gas generator burning a hydrocarbon fuel for creation of combustion gases that is operably interconnected with a free turbine that receives combustion gases and rotates a turbine shaft in response thereto. An electrical generator is mounted in communication with the free turbine for the generation of electricity upon rotation of the turbine shaft. A trailer body that is towable by a conventional tractor or truck is provided having a floor on which the gas generator, free turbine and electrical generator are mounted. The trailer body has end and side walls and a roof enclosing the gas generator, free turbine and electrical generator.

The trailer body is provided with an air inlet near one end for passage of air to the gas generator, and the free turbine has an exhaust for exit of the combustion gases. The trailer body has a combustion gas outlet formed in a side wall thereof for exit of the combustion gases from the free turbine. The gas generator, free turbine and electrical generator each have a longitudinal axis about which certain of their power generating components rotate during their operation. The longitudinal axes of the gas generator, free turbine and electrical generator are longitudinally aligned along a common axis along the longitudinal extent of the floor of the trailer body. This mobile trailer-mounted power generation system is easily connectable to other road-transportable units that provide for removal of undesirable components of the combustion gases without increasing the height or width of the trailer body of the power generation system. The mobile, trailer-mounted power generation system permits modularization of components to achieve generation of electrical power from a road-transportable unit while complying with height and weight limits for highway travel and also meeting both noise and environmental requirements.

However, even with this improvement, there are still problems meeting environmental limitations regarding the type and acceptable concentration levels of combustion waste products produced by this equipment. In addition, noise from the various components of the generator systems must be kept within presently established regulatory limits.

All hydrocarbon-burning combustion engines (including gas turbines) produce exhaust gasses that have been deemed harmful to the environment. Specifically, oxides of nitrogen (NOx) and carbon monoxide (CO) have been identified as compounds that should be minimized. Within the gas turbine community, one basic strategy for dealing with this issue is combustion process modification, specifically by using wet processes.

Wet processes consist of the injection of water or steam into the combustion zone, either in a “neat” form or pre-mixed with the fuel being used, to help cool the combustion flame and thus suppress the production of NOx. Care must be taken with the quantity of water or steam being used, however, or excessive CO could result. Although generally considered effective, the disadvantages of the wet process include the need for significant quantities of raw water, the added expense of the needed pumps, tankage, water treatment equipment, metering valves, control system elaboration, labor and maintenance, and the use of steam and, especially water, has a life-shortening effect on various internal engine components. Thus, for mobile systems, wet processes have significant disadvantages.

Another issue is noise abatement in systems using aero derivative gas turbine (aircraft jet engine) technology. This type of prime mover is well noted for its prolific sound signature. Noise is generated at the engine inlet and exhaust as a function of massive quantities of air being moved, as well as at the engine casing from the rotation of the engine's core and the associated resonances. In past designs, very little importance was placed on the abatement of this noise signature.

Accordingly, a need exists for a road-transportable system that efficiently reduces combustion waste products emitted from a trailer-mounted mobile electrical power generation system. A similar need exists to keep noise from the various components of the system within presently established regulatory limits.

### SUMMARY OF THE INVENTION

The present invention is directed to a new and improved road-transportable emissions control system for a mobile power system that satisfies this need.

One embodiment of the present invention includes a first duct module comprising a plurality of turning vanes for directing the flow of combustion gases from the exhaust of a combustion engine in a power trailer and a silencer section. This embodiment may further include a second duct module connected to the first duct module for mixing the combustion gases with a urea mixture. A third duct module may be connected to the second duct module comprising at least one catalyst block.

In one embodiment, the duct modules may be connected to each other in a dual-gasketing arrangement comprising a first inside gasket and a second outside gasket.

Another embodiment can have at least one catalyst block mounted to an A-frame structure in the third duct module.

In one embodiment, the emissions control system duct modules are road transportable.

Another embodiment can be a method of operating an emissions control system for a trailer-mounted mobile electrical power generation system. The method includes providing a first duct module comprising a plurality of turning vanes for directing the flow of combustion gases from the exhaust of a combustion engine in a power trailer and a silencer section. The method further includes providing a second duct module connected to the first duct module for mixing the combustion gases with a urea mixture. Next, a third duct module may be provided that may be connected to the second duct module and comprises at least one catalyst block.

The method further includes conveying combustion gases from a hydrocarbon-burning combustion engine in a trailer enclosure into the first duct module and attenuating noise from the sound of the hydrocarbon-burning combustion engine and directing the combustion gases into the second duct module. Next, urea may be injected into the combustion gases and decomposes into by-products including ammonia. The combustion gases and ammonia are mixed and then directed to the third duct module where the mixture passes over at least one catalyst block to removing effluents. Then, the combustion gases are directed outside the third duct module.

In another embodiment, the method of operating an emissions control system for a trailer-mounted mobile electrical power generation system further includes the step of providing a dual-gasketing arrangement where the duct modules are connected to each other comprising a first inside gasket and a second outside gasket.

In another embodiment, the method of operating an emissions control system for a trailer-mounted mobile electrical power generation system further includes the step of mounting at least one catalyst block to an A-frame structure in the third duct module.

In yet another embodiment of the method of operating an emissions control system for a trailer-mounted mobile electrical power generation system, there may be a step of providing duct modules that are road transportable.

### BRIEF DESCRIPTION OF THE DRAWINGS

These and other features, aspects and advantages of the present invention will become better understood with regard to the following description, appended claims and accompanying drawings where:

FIG. 1 shows an example of a top plan view of one embodiment of an emissions control system for a trailer-mounted mobile electrical power generation system.

FIG. 2 shows an example of a side elevation view of one embodiment of an emissions control system for a trailer-mounted mobile electrical power generation system.

### DETAILED DESCRIPTION OF THE DRAWING

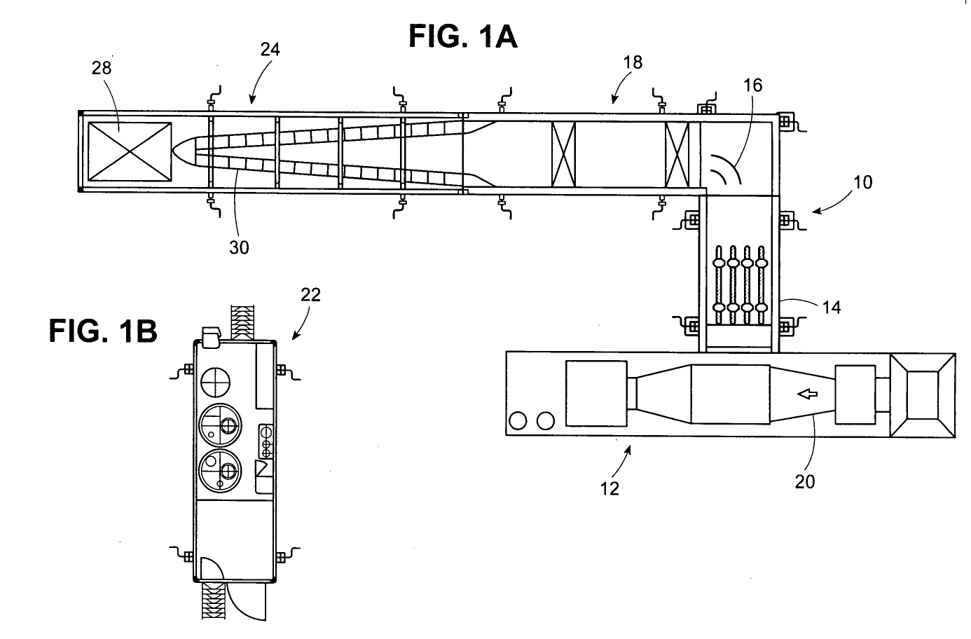

FIG. 1 shows an example of one embodiment of an emissions control system for a trailer-mounted mobile electrical power generation system. In FIG. 1, an emissions control system for a trailer-mounted mobile electrical power generation can include duct work designed in three separate modules. The first module 10 connected to the power trailer 12 may be a module that can incorporate a silencer section 14 and, at the end away from the power trailer, a set of turning vanes 16 that helps the exhaust gas make a ninety degree turn to turn the gas parallel with the axis of the remaining modules.

The second module 18 may connect to the first module 10 and can be a mixing module that can be used to mix the combustion gases that are coming from a hydrocarbon-burning combustion engine, such as a gas turbine 20, with a urea mixture that may be fed from a control trailer 22. Once that may be a homogenous mixture, the urea mixture flashes off into a vapor and may be broken down into by-products that include ammonia.

The ammonia may be mixed homogeneously with the exhaust gas and then travels into the third module 24 of the ductwork that may be where a catalyst if found. The third module 24 may be connected to the second module 18. The catalyst may be a ceramic honeycomb structure that has a platinum oxide overlayment.

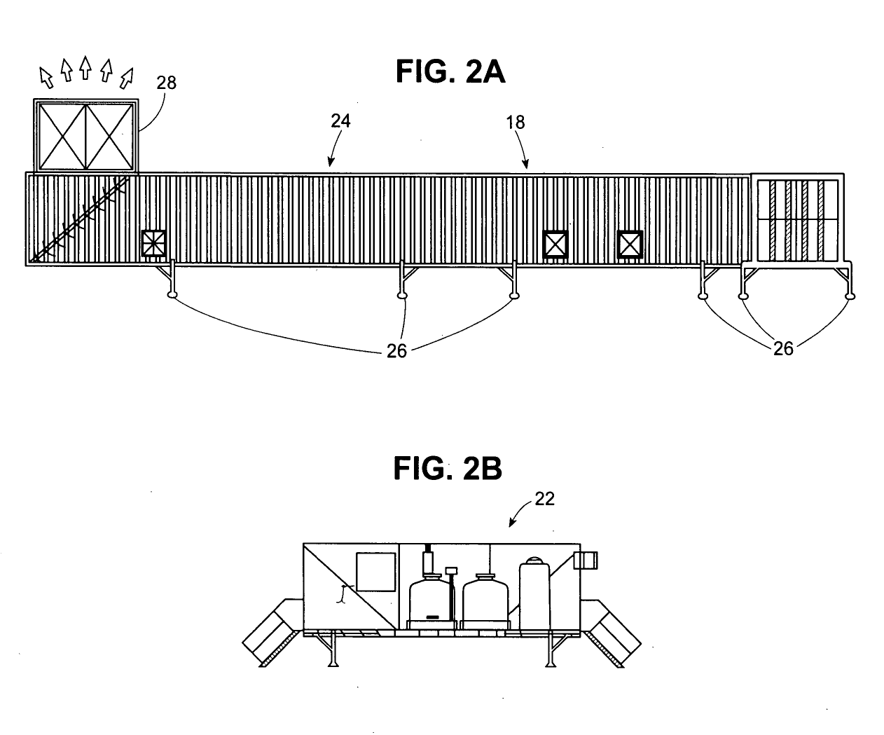

FIG. 2 shows an example of a side elevation view of an exemplary emissions control system for a trailer-mounted mobile electrical power generation system installation. The exhaust modules can have a number of jacklegs 26 that extend down to provide support. Those jacklegs 26 can be transported separately when the modules are on trailers, for example, and once they arrive on site, the jacklegs 26 may be attached to the side of the trailers. Once jacklegs 26 are dropped, the trailer can be pulled away from underneath of the system. Also, the system may be set up so that if in a confined area, or if more advantageous, the modules can be lifted and set in place. Furthermore, the ease of placement of the modules may be facilitated by features on the modules that allow a number of different ways of handling. In one embodiment, the system may be set up with the corner modules where the exhaust gas takes a ninety degree bend. That set of jacklegs 26 may be left with stakes that may be staked into the ground, and so as the length of the exhaust track expands, the legs may be equipped with rollers. The rollers may roll on pads that can be provided so the system has room to accommodate thermal expansion.

The modules are preferably sized so that they can be transported on a standard lowboy trailer without permit. Preferably, none are excessively heavy to require permits, and none are dimensionally unacceptable for any roadway in North America.

Along the edge of the modules in one embodiment are a number of man way type entrances into the exhaust ducts to allow for equipment inspections maintenance activities such as catalyst replacement.

In one embodiment, the exhaust duct modules may be connected to each other using heavy-duty clamps that actually draw the modules towards each other. Alternatively, the modules may be connected by other fasteners such as bolts. There may also be a sealing arrangement between the modules. An exemplary sealing arrangement may include a standard boiler gasket or rope gasket with a braid running around its circumference. Outside of that first gasket, there may be a secondary gasket. A suitable material for this secondary gasket may be Teflon tape. With the two gaskets in place and the clamps clamped per the manufacturer's recommendation, exhaust gases will be held in the duct, channeled through the system and treated as designed. The dual gasketing arrangement may be unique in ensuring no exhaust gas leakage.

In one embodiment, the entrance hole in the end of the exhaust duct closest to the power trailer 12 may not be centered in the duct structure. A reason for this offset may be to minimize turbulence in the exhaust flow as it comes out of, for example, a gas turbine 20. Some turbulence here may have the effect of destroying the exhaust duct in that area.

In one embodiment, the structure of the modules may include dual walls. The walls, ceiling and floor may have dual panels; an inner panel and outer panel. Between the two panels may be inserted sound attenuating material, such as fiberglass type insulation for both sound attenuation and thermal insulation. The external panels may be made of corrugated steel or carbon steel. Preferably, the external panels are painted. The internal panels are preferably perforated stainless steel. The perforations on the inner panels may serve to help with sound attenuation by allowing sound to go into the sound attenuation material instead of being reflected directly down the ducts.

In one embodiment, the exhaust structure 28 at the end where gases exit from the module 24 may be a structure that may be extended and retracted. The structure 28 may nest inside the module 24 for shipping, and once on site, there may be a mechanism, such as a chain and cranking arrangement that can be used to extend the structure 28. Once extended, there may be a flashing and gasketing arrangement that seals to keep exhaust gas from leaking by the joint at the top of the module 24, so exhaust gas may be directed up through the exhaust structure 28.

Control trailer 22 may house pumps, tanks and control and water treatment systems. Urea may be brought into trailer 22 in pellet form. One advantage of using urea versus more traditional means of ammonia injection, which would be hydrous or anhydrous ammonia, may be that it obviates the need to have a large quantity of ammonia gas available for a selective catalytic reduction (SCR) process. Urea may also be an inert product that reduces the need to have protection systems that may be required for ammonia systems. For ammonia systems, normally there may be a deluge system over the ammonia tank. If there is a tank leak, procedures may require deluging it with water to help dissipate the cloud and also to reduce the concentration of ammonia. Urea also may reduce the risk associated with having a highly pressurized gas on site and the potential for leaks. Similarly, normal injection tank pressure for ammonia systems can be as high as 1400-1600 psig. The air pressure that may be uses for injecting a urea solution may be comparatively low pressure at about 145 psig. Thus, the advantages of urea include much lower and safer pressure systems, a much safer product, easier to transport to and from the site, and much safer for people surrounding the site. If near a high traffic area or a high population density area, having urea on site versus having anhydrous or hydrous ammonia may be much safer.

The urea can be put into a mixing tank that may include a mechanical mixer along with water that has been treated. A suitable method of water treatment can be reverse osmosis. A water system may provide water to the mixing tank where a urea solution can be mixed and then may be moved into an injection tank. There may also be a water storage tank in the trailer 22 and also a small waste tank. The influent water for the system may be potable water. A water connection can be a standard garden hose type connection so if there is a water supply or well water hookup within the vicinity, any water of that quality can be used for this system, preferably as long as it is potable. The urea solution may be ready for injection once it may be in the injection tank. The solution may then be injected into the exhaust gas stream with the help of compressed air. In one embodiment, there may be an air compressor associated with this system that helps mix the solution and push it through injection quills and into the exhaust gas stream.

The trailer 22 may have a control system that takes various outputs from the combustion engine control system and can program the urea injection based on these parameters. Examples of functions that can be provided in the urea injection control system include starting and stopping the urea injection. The trailer 22 may also include electrical connections to support the machinery within the trailer 22. A suitable voltage rating for this machinery may be 480 volts AC.

Operational Overview

It was discussed above that one basic strategy for dealing with the issue of effluents, such as oxides of nitrogen (NOx) and carbon monoxide (CO), is combustion process modification, specifically by using wet processes. However, it was also noted that the disadvantages of the wet processes include the need for significant quantities of raw water, the added expense of the needed pumps, tankage, water treatment equipment, metering valves, control system elaboration, labor and maintenance, and the use of steam and, especially water, has a life-shortening effect on various internal engine components.

Another type of process—a dry process—may normally a combination of modified combustion controls and internal combustion zone engine components. By precisely controlling the flame size, shape, position and temperature, emissions can be minimized without the addition of water or steam. By using this type of equipment, harmful emissions can be reduced without the need for all of the additional equipment, raw water and effort associated with wet technologies. In one embodiment, dry process technology has been incorporated into the present system.

In addition to the dry combustion modification process, an exhaust stream treatment process to further reduce the exhaust emissions profile has been incorporated into one embodiment of the present invention. Known as selective catalytic reduction (SCR), this process adds ammonia (NH3) to the exhaust stream where it may be mixed in and then passed over a catalyst bed. The SCR techniques may, for example, be those found in U.S. Pat. Nos. 5,431,893 and 5,601,792, both to Hug et al, which are incorporated herein by reference.

By combining the results of the dry combustion modification process and the exhaust stream treatment process, a mobile power system may be capable of delivering a significant quantity of electrical power in temporary or emergency situations while producing exhaust emissions commensurate with permanently installed, state-of-the-art technology designs.

In one embodiment of the present invention, exhaust gas may be passed from the gas turbine enclosure 12 through a set of dual expansion joints and enters into the first module 10 where there may be a set of sound attenuation baffles 14 to reduce the sound of the engine, and then directed at a ninety-degree angle toward a mixing module 18. Also, at the exit of the sound attenuation baffles 14, there may be a set of injection quills that allow a reagent solution, for example, urea, to be injected into the exhaust stream. Preferably, urea is not injected into the exhaust stream until the system is around two thirds of full output. One reason for this may be to have the exhaust gas hot enough to perform the process. Otherwise, there may be the possibility of not completely hydrolyzing the urea and clogging the catalyst.

The urea may then be mixed with the exhaust gas in the mixing module 18 where it becomes a homogenous mixture as it exits that module 18. In one embodiment, the mixing module 18 may include a set of geometrically set panels that are built to provide a tortuous path and provide a certain amount of resonance time with the urea against the exhaust gas to facilitate the reaction. If the mixing module 18 was not utilized, i.e., an open exhaust duct instead of the mixing module 18, the exhaust duct would have to be about 4½ times the length that it is to provide adequate resonance time for the reaction to occur and to provide enough distance for a homogenous mix without benefit of any type of mixing device.

Once the exhaust gas passes through the mixing module 18, it goes into module 24 that in one embodiment may be where the catalyst catalyst blocks are produced by Engelhart. That company may make standard catalyst blocks for many different applications, gas turbines being one of them.

In one embodiment of the module 24, a narrow cross-sectional area may be preferred to keep the system transportable. However, in order to avoid having a problem as a result of a narrow cross-sectional area, catalyst blocks may be mounted into an A-frame structure 30 in module 24. The A-frame 30 may allow for a large surface face area for the exhaust gas and ammonia mixture to react with the catalyst block and then pass around and through the blocks to the exit of the exhaust 28. Preferably, the transition area where the exhaust gas enters into the A-frame 30 may be smooth in order to minimize exhaust rumble. A similar preference for smoothness exists at the release point area at the tip of the A-frame 30 where the exhaust gas may be coming off and then making the turn to exit so that flow disturbances and acoustic problems may be avoided.

Although the present invention has been described in considerable detail, other alternative versions are possible. Therefore, the spirit and scope of the appended claims should not be limited to the description of the versions contained herein.

What is claimed is:

1. An emissions control system comprising:
a first duct module comprising a plurality of elements for directing the flow of combustion gases from the exhaust of a combustion engine and at least one component to attenuate sound;
a second duct module connected to the first duct module for mixing the combustion gases with a reagent; and
a third duct module connected to the second duct module comprising at least one catalyst element.

2. The emissions control system of claim 1 wherein the duct modules are connected to each other in a seal arrangement comprising a first inside seal and a second outside seal.

3. The emissions control system of claim 1 wherein the at least one catalyst element is mounted to a structure in the third duct module.

4. The emissions control system of claim 1 wherein the duct modules are portable.

5. A method of operating an emissions control system comprising the steps of:
providing a first duct module comprising a plurality of elements for directing the flow of combustion gases from the exhaust of a combustion engine and at least one component to attenuate sound;
providing a second duct module connected to the first duct module for mixing the combustion gases with a reagent;
providing a third duct module connected to the second duct module comprising at least one catalyst element;
conveying combustion gases from a combustion engine into the first duct module;
attenuating noise from the sound of the combustion engine and directing the combustion gases into the second duct module;
injecting reagent into the combustion gases wherein the reagent decomposes into by-products;
mixing the combustion gases and by-products;
directing the mixture of combustion gases and by-products into the third duct module;
passing the mixture of combustion gases and by-products over the at least one catalyst element for removing effluents therein; and
directing the combustion gases outside the third duct module.

6. The method of operating an emissions control system of claim 5 further comprising the step of providing a seal arrangement where the duct modules are connected to each other comprising a first inside seal and a second outside seal.

7. The method of operating an emissions control system of claim 5 further comprising the step of mounting the at least one catalyst element to a structure in the third duct module.

8. The method of operating an emissions control system of claim 5 further comprising the step of providing duct modules that are portable.
